(19) United States
(12) Patent Application Publication
(10) Pub. No.: US 2018/0095013 A1
(43) Pub. Date: Apr. 5, 2018

(54) Apparatus and Method for Detecting Pollution Location and Computer Readable Recording Medium

(71) Applicant: WITHTECH INC., Daejeon (KR)

(72) Inventors: Seoung Kyo Yoo, Daejeon (KR); Eung Sun Lee, Daejeon (KR)

(21) Appl. No.: 15/555,649

(22) PCT Filed: Mar. 2, 2016
(86) PCT No.: PCT/KR2016/002051

§ 371 Date: Sep. 5, 2017

(30) Foreign Application Priority Data
Mar. 5, 2015 (KR) 10-2015-0030999

(51) Int. Cl. G01N 1/26; G01N 1/38

(52) U.S. Cl. CPC G01N 1/26; G01N 1/2273; G01N 2001/386; G01N 1/38

(57) ABSTRACT

Provided are an apparatus and a method for detecting a pollution location by including a plurality of sampling ports provided so that air is sucked from several points in a space to be measured and measuring pollution levels of air sucked from the respective sampling ports or some sampling ports that are grouped in the case in which an average pollution level of the air sucked from the plurality of sampling ports is out of a predetermined range. In the apparatus and a method for detecting a pollution location, a pollution level in a wide space may be effectively monitored.

### TECHNICAL FIELD

The present invention relates to an apparatus and a method for detecting a pollution location capable of detecting the pollution location by measuring a pollution level of a predetermined space.

### BACKGROUND ART

A clean room is a place in which a semiconductor manufacturing process, or the like, is performed. The clean room is divided into several classes depending on cleanliness, which is determined by the number of particles present per unit area and having a predetermined size, and a pollution source should be frequently recognized through precise measurement in order to always maintain and manage a predetermined level of cleanliness in the clean room.

Therefore, an important portion that may have an influence on the cleanliness should be recognized and frequently measured, and an accidental situation should be able to be predicted by regularly measuring several places in the clean room. In the clean room, it is important to constantly maintain and manage temperature, humidity, and pressure as well as recognize the cleanliness by analyzing particles.

Generally, in the clean room of a semiconductor manufacturing equipment, a particle measuring apparatus is used to perform a leak test on a filter of the clean room and measure internal particles of the clean room. However, after the filter provided on a ceiling of the clean room is installed, the filter is damaged due to internal and external changes, such that a filtering function thereof may be deteriorated.

Therefore, it is required to perform the leak test on the filter in order to verify securing of a stable clean room and securing of reliability of a semiconductor device. The leak test is performed in a scheme of scanning a surface of the filter while maintaining a predetermined distance from a lower end of the filter and measuring the number of particles present in air discharged from the filter.

However, since the clean room in which various semiconductor processes are performed has a very wide space, a method for measuring a pollution level by installing a sensor at a specific point is not appropriate for measuring a pollution level in a wide space.

In a method for measuring a concentration by a sensor installed at a specific point, since only the concentration at the specific point is measured, it is difficult to represent a concentration in a wide space. In the case in which several sensors are installed in order to solve this problem, an economical burden is excessively increased in covering the wide space.

A technology of forming a plurality of sampling ports in one measuring instrument and measuring concentrations in the plurality of sampling ports has been devised in order to solve this problem. However, since the concentrations in the plurality of sampling ports are sequentially measured by one measuring instrument, there was a disadvantage that it takes a very long time.

### DISCLOSURE OF INVENTION

### Technical Problem

The present invention has been suggested in order to solve the problem as described above. An object of the present invention is to provide an apparatus and a method for detecting a pollution location capable of effectively monitoring a pollution level in a wide space by including a plurality of sampling ports provided so that air is sucked from several points in a space to be measured and measuring pollution levels of air sucked from the respective sampling ports or some sampling ports that are grouped in the case in which an average pollution level of the air sucked from the plurality of sampling ports is out of a predetermined range.

### Solution to Problem

In one general aspect, an apparatus for detecting a pollution location in a space to be measured includes: a plurality of sampling ports 100 provided so that air is sucked from several points in the space to be measured; suction pipes 200 connected to the respective sampling ports 100; first control valves 410 installed on the suction pipes 200; a mixing part 500 connected to end portions of the suction pipes 200 to collect and mix the sucked air with each other; a detecting part 600 measuring a pollution level of the air passing through the mixing part 500 and then introduced thereinto; and a controlling part controlling the respective components, wherein the controlling part performs a control to open all of the first control valves 410, thereby allowing an average pollution level of the air sucked from the plurality of sampling ports 100 to be measured or to open some of the first control valves 410 and close the others of the first control valves 410, thereby allowing an average pollution level of air sucked from some of the sampling ports 100 to be measured.

In the case in which the average pollution level of the air sucked from the sampling ports 100 is out of a predetermined range, the controlling part may perform a control to sequentially open the first control valves 410 only one by one and perform a control to allow a pollution level of air sucked through a suction pipe 200 connected to the opened first control valve 410 to be measured.

The plurality of sampling ports 100 may be mounted in one space or may be mounted in a plurality of separated spaces, respectively.

The apparatus for detecting a pollution location may further include first flow rate adjusting parts 810 installed on the suction pipes 200, and may further include a vacuum pump 830 connected to the mixing part 500 and applying negative pressure so that the air is sucked from the sampling ports 100.

The apparatus for detecting a pollution location may further include a second flow rate adjusting part 820 disposed between the mixing part 500 and the vacuum pump 830.

The mixing part 500 may have a pipe shape in which pipes each connected to end portions of the suction pipes 200 are merged with each other as one pipe or may have a mixing chamber form including a separate mixing means.

In another general aspect, a method for detecting a pollution location using an apparatus detecting a pollution location including a plurality of sampling ports 100 provided so that air is sucked from several points in a space to be measured; suction pipes 200 connected to the respective sampling ports 100; first control valves 410 installed on the suction pipes 200; a mixing part 500 connected to end portions of the suction pipes 200 to collect and mix the sucked air with each other; a detecting part 600 measuring a pollution level of the air passing through the mixing part 500 and then introduced thereinto; and a controlling part controlling the respective components includes: a) opening all of the first control valves 410 provided on the suction pipes 200; b) measuring, by the detecting part 600, an average pollution level of introduced air; c) closing some of the first control valves 410 in the case in which the average pollution level measured by the detecting part 600 is out of a predetermined range; d) again measuring, by the detecting part 600, a pollution level of introduced air, and deciding that a leak is not present in a corresponding sampling port 100 from which the air is introduced when the measured pollution level is a predetermined reference value or less for a predetermined measurement time section; and e) repeating the steps c) and d) to detect a sampling port 100 in which the leak is present.

When the measured pollution level is smaller than the predetermined reference value in an initial section of the predetermined measurement time section in the step d), the measurement time section may be shortened.

The method for detecting a pollution location may further include, after the step e), periodically measuring a pollution level of the sampling port in which the leak is present.

In still another general aspect, a method for detecting a pollution location using an apparatus detecting a pollution location including a plurality of sampling ports 100 provided so that air is sucked from several points in a space to be measured; suction pipes 200 connected to the respective sampling ports 100; first control valves 410 installed on the suction pipes 200; a mixing part 500 connected to end portions of the suction pipes 200 to collect and mix the sucked air with each other; a detecting part 600 measuring a pollution level of the air passing through the mixing part 500 and then introduced thereinto; and a controlling part controlling the respective components includes: a) grouping the sampling ports 100 into a plurality of groups; b) simultaneously opening first control valves 410 of sampling ports 100 belonging to any one of the groups and closing all of first control valves 410 of sampling ports 100 belonging to the other groups; c) measuring an average pollution level of air introduced from corresponding sampling ports 100 through the opened first control valves 410 and deciding that a leak is not present in sampling ports 100 of the corresponding group when the average pollution level is a predetermined reference value or less; d) sequentially repeating the steps b) and c) for all the groups to decide that the leak is present in sampling ports 100 belonging to a group for which the average pollution level becomes larger than the predetermined reference value and sequentially performing a pollution level test on the sampling ports 100 belonging to the group in which the leak is present; and e) detecting a sampling port 100 in which the leak is present through the step d).

In yet still another aspect, a method for detecting a pollution location using an apparatus detecting a pollution location including a plurality of sampling ports 100 includes: a) grouping the sampling ports 100 into a plurality of groups; b) measuring an average pollution level of air sucked into sampling ports 100 belonging to any one of the groups and deciding that a leak is not present in sampling ports 100 of the corresponding group when the average pollution level is a reference value or less; c) sequentially repeating the step b) for all the groups to decide that the leak is present in sampling ports 100 belonging to a group for which the average pollution level becomes larger than the reference value and sequentially performing a pollution level test on the sampling ports 100 belonging to the group in which the leak is present; and d) detecting a sampling port 100 in which the leak is present through the step c).

In yet still another aspect, a method for detecting a pollution location using an apparatus detecting a pollution location including a plurality of sampling ports 100 includes: a) measuring an average pollution level of air sucked into the plurality of sampling ports 100 and deciding that a leak is not present in the plurality of sampling ports 100 when the average pollution level is a reference value or less; b) deciding that the leak is present in any one of the sampling ports 100 and sequentially performing a pollution level test on the respective sampling ports 100, when the average pollution level is larger than the reference value in the step a); and c) detecting the sampling port 100 in which the leak is present through the step b), wherein in the performing of the pollution level test on the respective sampling ports 100, it is decided that that the leak is not present in a corresponding sampling port 100 when a measured pollution level is a predetermined reference value or less for a predetermined measurement time section, and when the measured pollution level is smaller than the predetermined reference value in an initial section of the predetermined measurement time section, the measurement time section is further shortened, and the pollution level test is performed.

In yet still another aspect, a method for detecting a pollution location using an apparatus detecting a pollution location including a plurality of sampling ports 100 includes: a) measuring an average pollution level of air sucked into the plurality of sampling ports 100 and deciding that a leak is not present in the plurality of sampling ports 100 when the average pollution level is a reference value or less; b) deciding that the leak is present in any one of the sampling ports 100 and sequentially performing a pollution level test on the respective sampling ports 100, when the average pollution level becomes larger than the reference value in the step a); c) detecting the sampling port 100 in which the leak is present through the step b); and d) periodically measuring a pollution level of air sucked from the sampling port 100 in which the leak is present, detected in the step c).

In yet still another aspect, a (computer) program implementing the method for detecting a pollution location described above may be stored in a computer readable recording medium, or may be installed in a recording medium form in the apparatus for detecting a pollution location described above to allow the method for detecting a pollution location described above to be implemented.

### Advantageous Effects of Invention

In the present invention, a pollution level in a wide space may be effectively monitored.

In addition, in the present invention, several sampling ports are disposed in the wide space, and an average pollution level in a space to be measured is managed, thereby making it possible to rapidly detect a pollution source at the time of occurrence of an event.

That is, in the present invention, average data on pollution levels in a zone in which the sampling ports are mounted are managed, thereby making it possible to manage the pollution level in the wide space using one apparatus. In addition, concentrations in the respective sampling ports are sequentially scanned or are individually scanned by a specific sequence in order to recognize the pollution source when the average pollution level rises, thereby making it possible to rapidly detect a pollution zone.

In the present invention, rapid space pollution level generation capture and pollution location capture are possible, one measuring instrument (detecting part) is used, thereby making it possible to remove an error between measuring instruments, and a cost may be significantly decreased as compared with an existing scheme of using several measuring instruments.

### BRIEF DESCRIPTION OF DRAWINGS

FIG. 1 is a conceptual diagram illustrating 2-way valves each installed in suction pipes and branch pipes of an apparatus for detecting a pollution location according to the present invention.

FIG. 2 is a conceptual diagram illustrating 3-way valves installed in suction pipes of an apparatus for detecting a pollution location according to the present invention.

FIG. 3 is a conceptual diagram illustrating a discharge pipe included in an apparatus for detecting a pollution location according to the present invention.

FIG. 4 is a conceptual diagram illustrating a vacuum pump and a second flow rate adjusting part included between a mixing part and a discharge pipe of an apparatus for detecting a pollution location according to the present invention.

FIG. 5 is a conceptual diagram illustrating one 2-way valve installed in only each of the suction pipes of an apparatus for detecting a pollution location according to the present invention.

FIG. 6 is a conceptual diagram illustrating the second flow rate adjusting part and the vacuum pump included between the mixing part and the discharge pipe.

### BEST MODE FOR CARRYING OUT THE INVENTION

Hereinafter, an apparatus and a method for detecting a pollution location for measuring a pollution level according to the present invention will be described in detail with reference to the accompanying drawings.

First, an apparatus 1 for detecting a pollution location according to the present invention, which is to measure a pollution level in a space to be measured, has been devised particularly so as to effectively measure a pollution level even in a wide space.

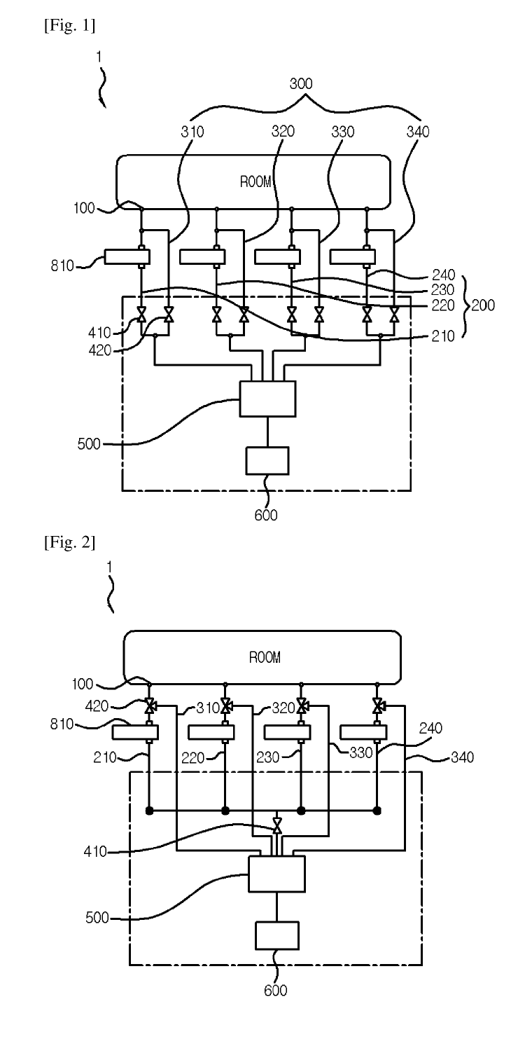

FIG. 1 is a conceptual diagram illustrating 2-way valves each installed in suction pipes and branch pipes of an apparatus for detecting a pollution location according to the present invention.

As illustrated in FIG. 1, the apparatus 1 for detecting a pollution location according to the present invention is configured to include sampling ports 100, suction pipes 200, branch pipes 300, a mixing part 500, a detecting part 600, and a controlling part (not illustrated).

The number of sampling ports 100, which suck air from several points in a space to be measured, is plural.

Here, in the apparatus 1 for detecting a pollution location according to the present invention, the plurality of sampling ports 100 may be installed in one clean room space or may be each installed in a plurality of separated spaces in a clean room.

When describing a semiconductor clean room by way of example, in the apparatus 1 for detecting a pollution location according to the present invention, the plurality of sampling ports 100 may be installed at several points in order to recognize which point in one clean room is exposed to pollution.

In addition, when the apparatus 1 for detecting a pollution location according to the present invention is to measure pollution levels of several semiconductor clean rooms using one equipment, the sampling ports 100 may also be installed in the clean rooms, respectively.

The suction pipes 200 are pipes connected to the sampling ports 100, and an air flow may be adjusted by first control valves 410 installed on the suction pipes 200.

The number of suction pipes 200 corresponds to that of sampling ports 100, and the number of first control valves 410 also corresponds to that of sampling ports 100.

As another example, as illustrated in FIG. 2, the first control valve 410 is a solenoid valve collectively controlling the plurality of suction pipes 200 and may be disposed at a front end of the mixing part 500. FIG. 2 is a conceptual diagram illustrating 3-way valves installed in suction pipes of an apparatus for detecting a pollution location according to the present invention.

The branch pipes 300 are pipes branched from the suction pipes 200, and an air flow may be adjusted by second control valves 420 installed on the branch pipes 300.

The suction pipe 200 and the branch pipe 300 are two passages through which air sucked through one sampling port 100 flows, and it is determined depending on opening and closing operations of the first and second control valves 410 and 420 whether or not the air flows.

Here, it is preferable that the first and second control valves 410 and 420 are solenoid valves so that they are easily controlled.

In addition, the second control valve 420 may be a 3-way valve disposed at a point of the suction pipe 200 from which the branch pipe 300 is branched as illustrated in FIG. 2 or be a 2-way valve as illustrated in FIG. 1.

The mixing part 500 is connected to end portions of the suction pipes 200 and the branch pipes 300 to collect and mix the air sucked from the plurality of sampling ports 100 with each other. The mixing part 500 may have a pipe shape in which pipes each connected to end portions of the plurality of suction pipes 200 and branch pipes 300 are merged with each other as one pipe.

As another example, the mixing part 500 may be a mixing chamber including a separate mixing means such as an agitator. In addition, the mixing part 500 may be variously modified as long as it may uniformly mix the air sucked from the plurality of suction pipes 200 or branch pipes 300 with each other.

The detecting part 600, which is a means measuring a pollution level of the air passing through the mixing part 500 and then introduced thereinto, may include a pump disposed therein in order to suck the air or may include a separate pump attached thereto in the case in which the pump is not disposed therein.

Here, as the detecting part 600, an appropriate kind of equipment may be used depending on a pollution source to be measured or a measuring method.

The controlling part performs an operation of controlling the respective components of the apparatus 1 for detecting a pollution location.

Particularly, in the present invention, the controlling part simultaneously opens the plurality of first control valves 410 to allow the detecting part 600 to allow an average pollution level of the air sucked from the plurality of sampling ports 100 to be measured.

In the case in which the average pollution level of the air sucked from the plurality of sampling ports 100 is out of a predetermined range, the controlling part closes the first control valves 410 and sequentially opens a plurality of second control valves 420 one by one or opens some of the plurality of second control valves 420 to allow pollution levels of air sucked from some sampling ports 100 corresponding to the opened second control valves 420 to be measured.

As illustrated in FIG. 1, the apparatus 1 for detecting a pollution location according to an exemplary embodiment of the present invention may include first flow rate adjusting parts 810 provided on the suction pipes 200 and adjusting a flow rate of the sucked air.

The apparatus 1 for detecting a pollution location according to an exemplary embodiment of the present invention sucks the air by opening all of the plurality of suction pipes 200 in order to measure the average pollution level. In this case, amounts of air sucked through the respective suction pipes 200 need to be decreased as compared with in the case of sucking the air by opening only one branch pipe 300. Therefore, in the apparatus 1 for detecting a pollution location according to an exemplary embodiment of the present invention, the amounts of air sucked through the respective suction pipes 200 may be adjusted through the first flow rate adjusting parts 810.

That is, in the apparatus 1 for detecting a pollution location according to an exemplary embodiment of the present invention, since an amount of sample that may be sucked and measured in the detecting part 600 should be constantly maintained, an adjustment is made so that only 1/N (here, N indicates the number of sampling ports 100) of an entire amount of air that may be sucked is introduced through one suction pipe 200.

Therefore, when the apparatus 1 for detecting a pollution location according to the present invention measures the average pollution level, the air may be sucked from the respective points through the first flow rate adjusting parts 810 by flow rates set in the suction pipes 200.

In addition, the apparatus 1 for detecting a pollution location according to the present invention may include a vacuum pump 830 connected to the mixing part 500 and applying negative pressure so that the air from the sampling ports 100 is sucked.

The vacuum pump 830 serves to rapidly suck the air of the respective sampling ports 100 for a rapid reaction in the case in which a suction flow velocity of the detecting part 600 is slow. In the apparatus 1 for detecting a pollution location according to an exemplary embodiment of the present invention, a flow rate of the air sucked through each of the sampling ports 100 is very small, a flow velocity of the air may be very slow. Therefore, it is preferable that the apparatus 1 for detecting a pollution location includes the vacuum pump 830 for the purpose of rapid suction and analysis of the air.

The apparatus 1 for detecting a pollution location according to an exemplary embodiment of the present invention may further include a discharge pipe 831 connected to a rear end of the vacuum pump 830 as illustrated in FIG. 3, and may further include a second flow rate adjusting part 820 disposed between the mixing part 500 and the vacuum pump 830. FIG. 3 is a conceptual diagram illustrating a discharge pipe included in an apparatus for detecting a pollution location according to the present invention.

Therefore, the apparatus 1 for detecting a pollution location according to an exemplary embodiment of the present invention may effectively monitor a pollution level in a wide space by reflecting an accurate concentration.

As described above, since a flow rate of the air sucked through the sampling ports 100 is a small amount in lpm unit, the apparatus 1 for detecting a pollution location according to an exemplary embodiment of the present invention may allow the remaining sampling air except for an amount of air that needs to be sucked into the detecting part 600 to be discharged through the discharge pipe 831, instead of increasing a flow velocity of the air arriving at the mixing part 500 by increasing the flow rate of the air sucked through each of the sampling ports 100.

That is, the apparatus 1 for detecting a pollution location according to an exemplary embodiment of the present invention sucks a high flow rate by the vacuum pump 830, thereby making it possible to suppress adsorption of the air in the suction pipes 200 and the branch pipes 300 and allow the pollution level to be rapidly and accurately measured by the detecting part 600.

A monitoring method according to an exemplary embodiment of the present invention using the apparatus 1 for detecting a pollution location according to the present invention having the above-mentioned configuration and feature may include: a) opening all of the first control valves 410 provided on the plurality of suction pipes 200 and closing all of the second control valves 420; b) measuring, by the detecting part 600, an average pollution level of air introduced through the suction pipes 200; c) closing all of the first control valves 410 in the case in which the measured average pollution level is out of a predetermined range; and d) sequentially opening the second control valves 420 one by one to individually measure pollution levels of air sucked from the respective sampling ports 100.

That is, in the monitoring method according to an exemplary embodiment of the present invention, in the case in which a specific event (abnormal pollution level) is not detected, all of the first control valves 410 are opened to suck the air through the plurality of sampling ports 100, whereby the average pollution level is measured by the detecting part 600.

In addition, in the case in which the specific event occurs, all of the first control valves 410 are closed and the second control valves 420 are sequentially opened one by one, such that the pollution levels of the air sucked from the respective sampling ports 100 are individually measured by the detecting part 600.

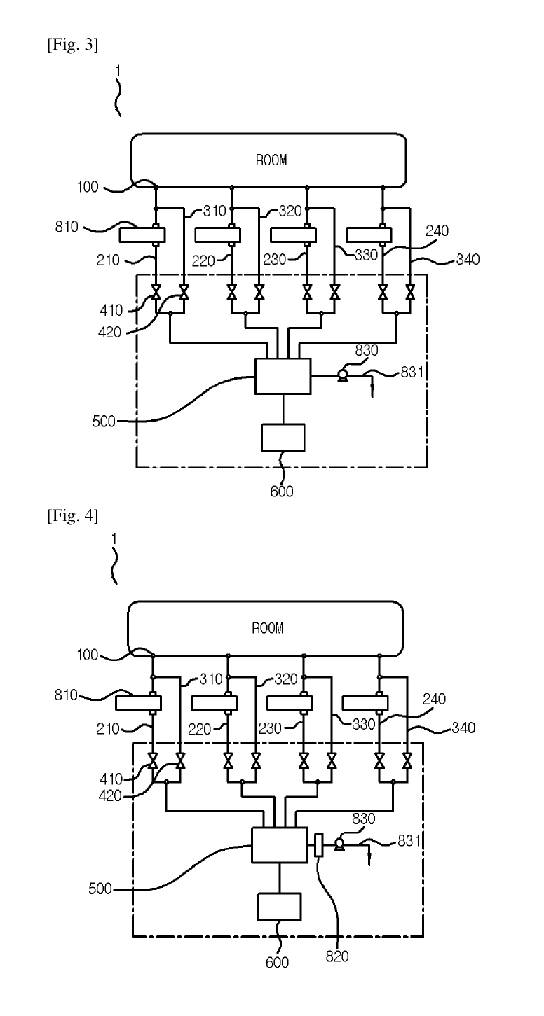

FIG. 4 is a conceptual diagram illustrating a vacuum pump and a second flow rate adjusting part included between a mixing part and a discharge pipe of an apparatus for detecting a pollution location according to the present invention.

The monitoring method according to an exemplary embodiment of the present invention using the apparatus 1 for detecting a pollution location according to the present invention illustrated in FIG. 4 will be described. First, from the left for convenience of explanation, the branch pipes 300 will be called a first branch pipe 310, a second branch pipe 320, a third branch pipe 330, and a fourth branch pipe 340, and the suction pipes 200 will be called a first suction pipe 210, a second suction pipe 220, a third suction pipe 230, and a fourth suction pipe 240.

In the case in which the event does not occur, in apparatus 1 for detecting a pollution location according to the present invention, the first control valves 410 on the first to fourth suction pipes 210, 220, 230, and 240 are opened, and the second control valves 420 on the first to fourth branch pipes 310, 320, 330, and 340 are closed.

When the vacuum pump 830 and the pump in the detecting part 600 are operated, air arrives at the mixing part 500 along the first to fourth suction pipes 210, 220, 230, and 240 through the sampling ports 100, and some of the air mixed with each other in the mixing part 500 is introduced into the detecting part 600, such that a pollution level thereof is measured, and the other thereof is discharged through the discharge pipe 831.

Here, air of about 5 lpm is sucked through each of the first to fourth suction pipes 210, 220, 230, and 240, and only 2 lpm of 20 lpm, which is the sum of the sucked flow rate, is introduced into the detecting part 600 and is used to measure the average pollution level and remaining 18 lpm is discharged through the discharge pipe 831.

When the average pollution level measured as described above is out of the predetermined range, all of the first control valves 410 are closed, and only the second control valve 420 on the first branch pipe 310 is opened.

Air of 20 lpm is sucked through the first branch pipe 310, only air of 21 lpm is introduced into the detecting part 600 and is used to measure the pollution level, and remaining 18 lpm is discharged through the discharge pipe 831.

Then, the second control valves 420 on the second branch pipe 320, the third branch pipe 330, and the fourth branch pipe 340 are sequentially opened, such that pollution levels of sucked air are individually measured, thereby analyzing through which sampling port 100 the pollution source has been introduced.

In addition, in the monitoring method according to an exemplary embodiment of the present invention, the pollution levels of the air sucked through the first to fourth branch pipes 310, 320, 330, and 340 are individually measured, and the first control valves 410 on the first to fourth suction pipes 210, 220, 230, and 240 are opened and the second control valves 420 on the first to fourth branch pipes 310, 320, 330, and 340 are closed at a predetermined point in time, thereby making it possible to measure the average pollution level.

That is, in the present invention, a mode of collectively measuring the average pollution level through the respective sampling ports 100 and a mode of measuring pollution levels per specific point may be variously selected and used as needed.

In addition, a method according to another exemplary embodiment of the present invention includes a) opening all of the first control valves 410 provided on the plurality of suction pipes 200 and closing all of the second control valves 420; b) measuring, by the detecting part 600, an average pollution level of the air introduced through the suction pipes 200; c) closing all of the first control valves 410 in the case in which the measured average pollution level is out of a predetermined range; d) opening some of the second control valves 420 depending on a predetermined sequence to measure an average pollution level of air sucked from the corresponding sampling ports 100; and e) closing some of the opened second control valves 420 to measure pollution levels of air sucked from the sampling ports 100, in the case in which the average pollution level measured in the step d) is out of a predetermined range, and closing the opened second control valves 420 and opening the closed second control valves 420 to measure pollution levels of air sucked from the sampling ports 100, in the case in which the average pollution level measured in d) is not out of the predetermined range.

That is, in the method according to another exemplary embodiment of the present invention, in the case in which a specific event does not occur, all of the first control valves 410 are opened to suck the air through the plurality of sampling ports 100, whereby the average pollution level is measured by the detecting part 600.

In addition, in the case in which the specific event occurs, all of the first control valves 410 are closed and some of the second control valves 420 are opened, such that the average pollution level of the air sucked through the corresponding sampling ports 100 is measured by the detecting part 600.

The method according to another exemplary embodiment of the present invention will be described in more detail. In the method according to another exemplary embodiment of the present invention, the same apparatus 1 as the apparatus used in the monitoring method according to an exemplary embodiment of the present invention is used, in the case in which the specific event does not occur, the first control valves 410 on the first to fourth suction pipes 210, 220, 230, and 240 are opened, and the second control valves 420 on the first to fourth branch pipes 310, 320, 330, and 340 are closed.

In addition, when the vacuum pump 830 and the pump in the detecting part 600 are operated, air arrives at the mixing part 500 along the first to fourth suction pipes 210, 220, 230, and 240, and some of the air mixed with each other in the mixing part 500 is introduced into the detecting part 600, such that a pollution level thereof is measured, and the other thereof is discharged through the discharge pipe 831.

Here, air of about 5 lpm is sucked through each of the first to fourth suction pipes 210, 220, 230, and 240, and only 2 lpm of 20 lpm, which is the sum of the sucked flow rate, is introduced into the detecting part 600 and is used to measure the average pollution level and remaining 18 lpm is discharged through the discharge pipe 831.

When the average pollution level measured as described above is out of the predetermined range, all of the first control valves 410 are closed. Processes up to now are the same as those of the first example.

Then, all of the second control valves 420 are not opened, but only some of the second control valves 420 are opened. For example, the second control valves 420 on the first and second branch pipes 310 and 320 among the second control valves 420 on the first to fourth branch pipes 310, 320, 330, and 340 are opened, and the second control valves 420 on the third and fourth branch pipes 330 and 340 are closed. In this case, the air is sucked through the first and second branch pipes 310 and 320, such that an average pollution level is measured by the detecting part 600.

In addition, when the average pollution level measured by the detecting part 600 is out of the predetermined range, the second control valve 420 on the second branch pipe 320, of the opened second control valves 420 on the first and second branch pipes 310 and 320 is closed, and the second control valve 420 of the first branch pipe 310 is maintained in a state in which it is opened. The air is sucked through the first branch pipe 310, such that a pollution level is measured by the detecting part 600. Here, when the pollution level measured by the detecting part 600 is not out of the predetermined range, the second control valve 420 on the first branch pipe 310 is closed and the second control valve 420 on the second branch pipe 320 is opened, such that a pollution level of the sucked air is measured.

On the other hand, when the average pollution level measured by the detecting part 600 is not out of the predetermined range in a state in which the second control valves 420 on the first and second branch pipes 310 and 320 are opened, both of the opened second control valves 420 on the first and second branch pipes 310 and 320 are closed, and the second control valves 420 on the third and fourth branch pipes 330 and 340 are opened. Then, the second control valve 420 on the fourth branch pipe 340, of the opened second control valves 420 on the third and fourth branch pipes 330 and 340 is closed, and the second control valve 420 on the third branch pipe 330 is maintained in a state in which it is opened. The air is sucked through the third branch pipe 330, such that a pollution level is measured by the detecting part 600. Here, when the pollution level measured by the detecting part 600 is not out of the predetermined range, the second control valve 420 on the third branch pipe 330 is closed and the second control valve 420 on the fourth branch pipe 340 is opened, such that a pollution level of the sucked air is measured.

The method according to another exemplary embodiment of the present invention may have an advantage that a pollution point in the space to be measured is rapidly detected when the number of branch pipes is plural.

Although two valves are installed for one sampling port 100 in the above-mentioned exemplary embodiments, only one 2-way valve may also be installed for one sampling port 100.

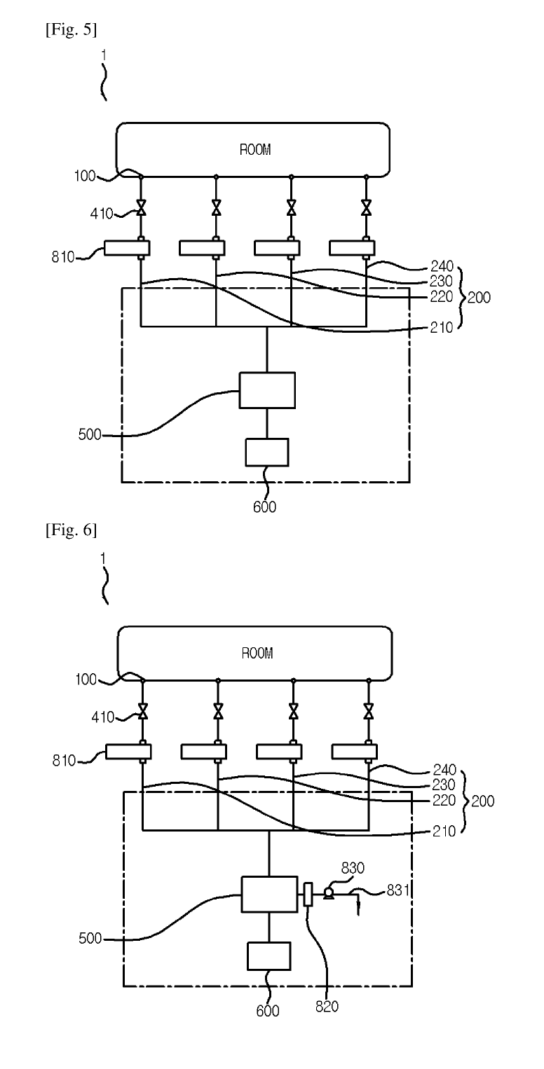

FIG. 5 is a conceptual diagram illustrating one 2-way valve installed in only each of suction pipes of an apparatus for detecting a pollution location according to the present invention.

The apparatus for detecting a pollution location illustrated in FIG. 5 is configured to include sampling ports 100, suction pipes 200, a mixing part 500, a detecting part 600, and a controlling part (not illustrated).

First flow rate adjusting parts 810 and first control valves 410 are installed in the suction pipes 210 to 240, respectively. A sequence of the first flow rate adjusting parts 810 and the first control valves 410 may be changed.

The controlling part may control the respective flow rate adjusting parts 810 and the respective first control valves 410 to adjust amounts of air introduced from the respective sampling ports 100.

For example, in order to suck the air from only the first suction pipe 210, the first control valve 410 of the first suction pipe 210 is opened and all of the first control valves 410 of the other suction pipes 220 to 240 are closed. In addition, in order to suck the air of the first and third suction pipes 210 and 230, the first control valve 410 of the first suction pipe 210 and the first control valve 410 of the third suction pipe 230 are opened, and both of the first control valves 410 of the other suction pipes 220 and 240 are closed. In order to suck the air of all of the suction pipes 210 to 240, the first control valves 410 of all of the suction pipes 210 to 240 are opened.

In addition, when sucking the air from several suction pipes 200, the first flow rate adjusting parts 810 of the respective suction pipes 200 are controlled, thereby making it possible to adjust a ratio of the air introduced from the respective suction pipes 200.

Further, also in the apparatus 1 for detecting a pollution location illustrated in FIG. 5, a discharge pipe 831 may be installed, and a second flow rate adjusting part 820 and a vacuum pump 830 may be installed between the mixing part 500 and the discharge pipe 831.

FIG. 6 is a conceptual diagram illustrating the second flow rate adjusting part and the vacuum pump included between the mixing part and the discharge pipe.

In an apparatus 1 for detecting a pollution location illustrated in FIG. 6, a second flow rate adjusting part 820 and a vacuum pump 830 may be installed between the mixing part 500 and the discharge pipe 831.

In the apparatus 1 for detecting a pollution location illustrated in FIG. 6, the remaining sampling air except for an amount of air that needs to be sucked into the detecting part 600 may be discharged through the discharge pipe 831, instead of increasing a flow velocity of air arriving at the mixing part 500 by increasing a flow rate of air sucked through each of the sampling ports 100.

That is, the apparatus 1 for detecting a pollution location according to an exemplary embodiment of the present invention sucks a high flow rate by the vacuum pump 830, thereby making it possible to suppress adsorption of the air in the suction pipes 200 and the branch pipes 300 and allow the pollution level to be rapidly and accurately measured by the detecting part 600.

In addition, in the apparatus 1 for detecting a pollution location illustrated in FIG. 5, a second flow rate adjusting part and a vacuum pump may also be installed between the mixing part 500 and the detecting part 600.

The second flow rate adjusting part and the vacuum pump installed between the mixing part 500 and the detecting part 600 serve to adjust an amount of air introduced into the detecting part 600.

The apparatuses 1 for detecting a pollution location according to exemplary embodiments of the present invention may be operated in three modes such as an integration mode, a scan mode, and a leak mode.

The integration mode is a mode of managing an average pollution level by sucking air from several sampling ports. In this mode, when the average pollution level is smaller than a predetermined value, it is decided that a leak of a pollutant is not present.

The scan mode is a mode of detecting a sampling port in which a leak is present by measuring pollution levels of air introduced from the respective sampling ports in the case in which it is decided that the average pollution level is out of a predetermined reference value.

The leak mode is a mode of continuously sampling the sampling port in which the leak is present after detecting the sampling port in which the leak is present.

When detecting the sampling port in which the leak is present by measuring the pollution levels of the air introduced from the respective sampling ports, in the case in which the pollution level measured for a predetermined measurement time section is a predetermined reference value or less, it is decided that the leak is not present in the selected sampling port 100. Here, as the measured pollution level becomes smaller than the predetermined reference value, the predetermined measurement time section may be further shortened.

For example, when it is decided that the leak is not present in the case in which a pollution level measured for five seconds is 10 or less, it may be decided that the possibility of the leak is very low when a pollution level measured for the first two seconds is 5 or less. Therefore, the measurement of the pollution level may be stopped in only two or three seconds without being continuously performed for five seconds.

A function of further shortening the predetermined measurement time section as the measured pollution level becomes smaller than the predetermined reference value may be called an acceleration function. As an experiment result, a scan speed was improved by 80% or more in the case in which the acceleration function is used than in the case in which the acceleration function is not used.

In addition, in the integration mode, the air may be introduced from all the sampling ports. Alternatively, after the sampling ports are grouped into a plurality of upper groups, pollution levels may be sequentially measured for the respective upper groups. For example, in the case in which hundred sampling ports are present, the hundred sampling ports are grouped into ten upper groups each including ten sampling ports, and pollution levels are sequentially measured for the ten upper groups. When an upper group for which a pollution level is a reference value or more is detected, pollution levels of sampling ports belonging to the upper group are sequentially measured, thereby making it possible to detect a sampling port in which the leak is generated.

In the case in which it is decided that the leak is present in one of the sampling ports belonging to a specific upper group to sequentially detect pollution levels of the sampling ports belonging to the specific upper group, the sampling ports belonging to a specific upper group may be grouped into several lower groups, and pollution levels may be sequentially detected for the several lower groups.

In addition, when the sampling ports are grouped, the numbers of sampling ports belonging to the respective groups are not necessarily the same as each other, but may be different from each other, if necessary. For example, the number of sampling ports belonging to any group may be five, the number of sampling ports belonging to another group may be three, and the number of sampling ports belonging to the other group may be one.

In addition, when the sampling ports are grouped into several groups, the sampling ports are grouped into the several groups by several references. However, when sampling ports of points at which pollution levels are measured as similar values are grouped into the same group, the leak may be more rapidly and accurately detected.

For example, when pollution levels of first to sixth sampling ports are 20, 21, 10, 9, 8, and 1, respectively, the first and second sampling ports may be grouped into one group, the third to fifth sampling ports may be grouped into another group, and the sixth sampling port may be grouped into the other group.

The methods according to exemplary embodiments of the present invention are implemented by installing a program (or a computer program) in the apparatus for detecting a pollution location according to the present invention. That is, the apparatus for detecting a pollution location according to the present invention includes a memory in which the program is stored. The program implementing the method for detecting a pollution location according to the present invention is stored in the memory (computer readable recording medium) to allow the apparatus for detecting a pollution location according to the present invention to implement the method for detecting a pollution location according to the present invention.

Therefore, in the apparatus and the methods for detecting a pollution location according to exemplary embodiments of the present invention, the plurality of sampling ports 100 are provided so that air is sucked from several points in a space to be measured, an average pollution level of air sucked from the plurality of sampling ports 100 is measured, and pollution levels of the air sucked from the sampling ports 100 are individually or partially measured in the case in which the measured average pollution level is out of a predetermined range. Therefore, a pollution level in a wide space may be effectively monitored.

In addition, in the present invention, several sampling ports 100 are disposed in a wide space, and the average pollution level in the space to be measured is managed, thereby making it possible to rapidly detect the pollution location in the case in which the leak is generated at a specific point.

That is, in the present invention, average data on pollution levels in a zone in which the sampling ports 100 are mounted are managed, thereby making it possible to manage the pollution level in the wide space using one apparatus, and concentrations in the respective sampling ports are sequentially scanned or are individually scanned by a specific sequence in order to recognize a pollution source when the average pollution level rises, thereby making it possible to rapidly detect a pollution zone.

Therefore, in the present invention, rapid space pollution level generation capture and pollution location detection are possible, one measuring instrument (detecting part 600) is used, thereby making it possible to remove an error between measuring instruments, and a cost may be significantly decreased as compared with an existing scheme of using several measuring instruments.

The present invention is not limited to the above-mentioned exemplary embodiments but may be variously applied, and may be variously modified by those skilled in the art to which the present invention pertains without departing from the gist of the present invention claimed in the claims.

### DETAILED DESCRIPTION OF MAIN ELEMENTS

1: apparatus for detecting pollution location
100: sampling port
200: suction pipe
210, 220, 230, 240: first to fourth suction pipes
300: branch pipe
310, 320, 330, 340: first to fourth branch pipes
410: first control valve
420: second control valve
500: mixing part
600: detecting part
810: first flow rate adjusting part
820: second flow rate adjusting part
830: vacuum pump
831: discharge pipe

1. An apparatus for detecting a pollution location in a space to be measured, comprising:
a plurality of sampling ports provided so that air is sucked from several points in the space to be measured;
suction pipes connected to the respective sampling ports;
first control valves installed on the suction pipes;
a mixing part connected to end portions of the suction pipes to collect and mix the sucked air with each other;
a detecting part measuring a pollution level of the air passing through the mixing part and then introduced thereinto; and
a controlling part controlling the respective components,
wherein the controlling part performs a control to open all of the first control valves, thereby allowing an average pollution level of the air sucked from the plurality of sampling ports to be measured or to open some of the first control valves and close the others of the first control valves, thereby allowing an average pollution level of air sucked from some of the sampling ports to be measured.

2. The apparatus for detecting a pollution location of claim 1, wherein in the case in which the average pollution level of the air sucked from the sampling ports is out of a predetermined range, the controlling part performs a control to sequentially open the first control valves only one by one and performs a control to allow a pollution level of air sucked through a suction pipe connected to the opened first control valve to be measured.

3. The apparatus for detecting a pollution location of claim 1, wherein the plurality of sampling ports are mounted in one space or are mounted in a plurality of separated spaces, respectively.

4. The apparatus for detecting a pollution location of claim 1, further comprising first flow rate adjusting parts installed on the suction pipes.

5. The apparatus for detecting a pollution location of claim 1, further comprising a vacuum pump connected to the mixing part and applying negative pressure so that the air is sucked from the sampling ports.

6. The apparatus for detecting a pollution location of claim 5, further comprising a second flow rate adjusting part disposed between the mixing part and the vacuum pump.

7. The apparatus for detecting a pollution location of claim 1, wherein the mixing part has a pipe shape in which pipes each connected to the end portions of the suction pipes are merged with each other as one pipe or has a mixing chamber form including a separate mixing means.

8. A method for detecting a pollution location using an apparatus detecting a pollution location including a plurality of sampling ports provided so that air is sucked from several points in a space to be measured; suction pipes connected to the respective sampling ports; first control valves installed on the suction pipes; a mixing part connected to end portions of the suction pipes to collect and mix the sucked air with each other; a detecting part measuring a pollution level of the air passing through the mixing part and then introduced thereinto; and a controlling part controlling the respective components, the method comprising the steps of:
a) opening all of the first control valves provided on the suction pipes;
b) measuring, by the detecting part, an average pollution level of introduced air;
c) closing some of the first control valves in the case in which the average pollution level measured by the detecting part is out of a predetermined range;
d) again measuring, by the detecting part, a pollution level of introduced air, and deciding that a leak is not present in a corresponding sampling port from which the air is introduced when the measured pollution level is a predetermined reference value or less for a predetermined measurement time section; and
e) repeating steps c) and d) to detect a sampling port in which the leak is present.

9. The method for detecting a pollution location of claim 8, wherein when the measured pollution level is smaller than the predetermined reference value in an initial section of the predetermined measurement time section in step d), the measurement time section is shortened.

10. The method for detecting a pollution location of claim 8, further comprising, after step e), periodically measuring a pollution level of the sampling port in which the leak is present.

11. A method for detecting a pollution location using an apparatus detecting a pollution location including a plurality of sampling ports provided so that air is sucked from several points in a space to be measured; suction pipes connected to the respective sampling ports; first control valves installed on the suction pipes; a mixing part connected to end portions of the suction pipes to collect and mix the sucked air with each other; a detecting part measuring a pollution level of the air passing through the mixing part and then introduced thereinto; and a controlling part controlling the respective components, the method comprising the steps of:
a) grouping the sampling ports into a plurality of groups;
b) simultaneously opening first control valves of sampling ports belonging to any one of the groups and closing all of first control valves of sampling ports belonging to the other groups;
c) measuring an average pollution level of air introduced from corresponding sampling ports through the opened first control valves and deciding that a leak is not present in sampling ports of the corresponding group when the average pollution level is a predetermined reference value or less;
d) sequentially repeating steps b) and c) for all the groups to decide that the leak is present in sampling ports belonging to a group for which the average pollution level becomes larger than the predetermined reference value and sequentially performing a pollution level test on the sampling ports belonging to the group in which the leak is present; and
e) detecting a sampling port in which the leak is present through step d).

12. A method for detecting a pollution location using an apparatus detecting a pollution location including a plurality of sampling ports comprising the steps of:
a) grouping the sampling ports into a plurality of groups;
b) measuring an average pollution level of air sucked into sampling ports belonging to any one of the groups and deciding that a leak is not present in sampling ports of the corresponding group when the average pollution level is a reference value or less;
c) sequentially repeating step b) for all the groups to decide that the leak is present in sampling ports belonging to a group for which the average pollution level becomes larger than the reference value and sequentially performing a pollution level test on the sampling ports belonging to the group in which the leak is present; and
d) detecting a sampling port in which the leak is present through step c).

13. A method for detecting a pollution location using an apparatus detecting a pollution location including a plurality of sampling ports, comprising the steps of:
a) measuring an average pollution level of air sucked into the plurality of sampling ports and deciding that a leak is not present in the plurality of sampling ports when the average pollution level is a reference value or less;
b) deciding that the leak is present in any one of the sampling ports and sequentially performing a pollution level test on the respective sampling ports, when the average pollution level is larger than the reference value in step a); and
c) detecting the sampling port in which the leak is present through step b),
wherein in the performing of the pollution level test on the respective sampling ports, it is decided that that the leak is not present in a corresponding sampling port when a measured pollution level is a predetermined reference value or less for a predetermined measurement time section, and when the measured pollution level is smaller than the predetermined reference value in an initial section of the predetermined measurement time section, the measurement time section is shortened, and the pollution level test is performed.

14. A method for detecting a pollution location using an apparatus detecting a pollution location including a plurality of sampling ports, comprising the steps of:
a) measuring an average pollution level of air sucked into the plurality of sampling ports and deciding that a leak is not present in the plurality of sampling ports when the average pollution level is a reference value or less;
b) deciding that the leak is present in any one of the sampling ports and sequentially performing a pollution level test on the respective sampling ports, when the average pollution level becomes larger than the reference value in step a);
c) detecting the sampling port in which the leak is present through step b); and
d) periodically measuring a pollution level of air sucked from the sampling port in which the leak is present, detected in step c).

15. A computer readable recording medium in which a program is recorded, wherein the program allows the method for detecting a pollution location of claim 8 to be implemented in an apparatus for detecting a pollution location.

16. A computer readable recording medium in which a program is recorded, wherein the program allows the method for detecting a pollution location of claim 11 to be implemented in an apparatus for detecting a pollution location.

17. A computer readable recording medium in which a program is recorded, wherein the program allows the method for detecting a pollution location of claim 12 to be implemented in an apparatus for detecting a pollution location.

18. A computer readable recording medium in which a program is recorded, wherein the program allows the method for detecting a pollution location of claim 13 to be implemented in an apparatus for detecting a pollution location.

19. A computer readable recording medium in which a program is recorded, wherein the program allows the method for detecting a pollution location of claim 14 to be implemented in an apparatus for detecting a pollution location.
